(19) United States
(12) Patent Application Publication
(10) Pub. No.: US 2014/0088736 A1
(43) Pub. Date: Mar. 27, 2014

(54) Consistency Analysis in Control Systems During Normal Operation

(71) Applicant: Management Analytics, Livermore, CA (US)

(72) Inventor: Frederick B. Cohen, Livermore, CA (US)

(73) Assignee: Management Analytics, Livermore, CA (US)

(21) Appl. No.: 13/865,752

(22) Filed: Apr. 18, 2013

Related U.S. Application Data
(60) Provisional application No. 61/625,679, filed on Apr. 18, 2012.

(51) Int. Cl. G05B 9/02

(52) U.S. Cl. CPC G05B 9/02
USPC 700/79

(57) ABSTRACT

A consistency analysis system provides consistency analysis for a control system that includes sensors for monitoring a number of different physical parameters. The analysis system uses a rules set and overlapping or redundant sensor data to determine alterations in system behavior or parameters even in the presence of subversion designed to alter or hide sensor trace data. Specific embodiments deliberate perturb the system or alters sensor data in order to detect whether other system or sensor data responds consistently to the perturbation. Specific embodiments also comprise associated methods performed by logic apparatus.

### CROSS REFERENCE TO RELATED APPLICATIONS

This application claims priority from provisional patent application 61/625,679, filed 18 Apr. 2012 and incorporated herein by reference. All referenced documents and application herein and all documents referenced therein are incorporated in by reference for all purposes. This application may be related to other patent applications and issued patents assigned to the assignee indicated above. These applications and issued patents are incorporated herein by reference to the extent allowed under applicable law.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### FIELD OF THE INVENTION

The description herein of specific embodiments relates generally to controlled systems with logic or information analysis apparatus and associated systems that use consistency analysis of data related to the system to guard against malicious alteration or subversion.

### BACKGROUND

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

Subversion of various physical or informational installations or facilities using deception techniques has been long understood as a serious threat to a variety of institutions. Both insiders and external saboteurs have altered or subverted control systems since such systems were first used.

### SUMMARY

According to specific embodiments, the present invention is involved with methods and/or systems and/or devices that can be used together or independently to detect generally deliberate or accidental alterations of the normal operations of controlled physical, cyber, and mixed environments, even in cases where the actor altering the environment takes steps to subvert normal detection systems and methods in those environments. In specific embodiments, consistency analysis of sensors and/or redundant sensors and/or effectors is used to detect alteration of system operations even in the presence of subversion. In further embodiments, the system includes one or more specific deliberate alteration or perturbation routines for a controlled system and uses a consistency checker to determine if the deliberate perturbations had the predicted effect on available trace data from sensors or other sources. Where the predicted effect is not observed, the system can take further action or alert to the presence of possible subversion efforts and/or diagnose possible causes of the observed effects. Thus, specific embodiments use consistency checking to defeat attempts to alter control systems, effectors, sensors, and/or signals between and/or among them.

### BRIEF DESCRIPTION OF THE DRAWINGS

FIG. 1 is a flow chart illustrating a method of detecting deceptive actions using consistency analysis in control systems during normal operation according to specific embodiments.

FIG. 2 is a flow chart illustrating a method of detecting deceptive actions in controlled systems using unpredictable deliberate alterations and consistency checking during normal system operations according to specific embodiments.

FIG. 3 is a flow chart illustrating a method of detecting deceptive actions in controlled systems using alterations of set points and consistency checking during normal system operations according to specific embodiments.

FIG. 4 is a flow chart illustrating a method of detecting deceptive actions using consistency analysis and complex time varying alterations in control systems to leverage computation complexity to thwart sophisticated attackers according to specific embodiments.

FIG. 5 is a block diagram showing a representative example logic system and logic modules according to specific embodiments.

FIG. 6 is a block diagram showing a representative example logic device in which various aspects of the present invention may be embodied.

### DESCRIPTION OF SPECIFIC EMBODIMENTS

### Overview

Consistency analysis has been found useful in detecting corruptions of all sorts, ranging from accidental bit flips (i.e., parity checking) in the 1960s, to multiple bit error detection (i.e., cyclical redundancy checks), to malicious alteration detection (i.e., cryptographic checksums)¹ in the 1980s, and has been used in digital forensics since at least the 1990s². These efforts have generally been in the purely digital space or the digital side of controlled environments. However, the digital and analog portions of industrial control systems and other control systems are increasingly converging. These systems are becoming increasingly vulnerable to complex corruptions of the combined digital and analog spaces. There is an increasing, though somewhat unrecognized, threat that such complex corruptions may be used to induce harmful physical effects through exploitation of combined digital and analog systems. ¹F. Cohen, “A Cryptographic Checksum for Integrity Protection”, IFIP-TC11 “Computers and Security”, V6#6 (December 1987), pp 505-810.²F. Cohen, “A Note on Detecting Tampering with Audit Trails'”, 1995

The use of cryptographic checksums for detection of intentional alteration is sometimes described as gaining its utility from the computational leverage of detection over forgery. The forger not holding the cryptographic key to generate a true cryptographic checksum for any desired bit sequence is unable to systematically forge sequences in which the cryptographic checksum is consistent with the content it covers within the time frame necessary to be useful in their forgery. While replay attacks and similar methods may function in systems not well designed to defeat them, such systems can be and have been designed and are successful in mitigating attacks—though only up to the point where the attacker is able to determine or use the cryptographic key, at which point forgery generally becomes feasible and inexpensive. Generally, the selection of the cryptographic checksum method is intended to be such that determining the cryptographic key takes a long time, and thus without infeasible computational capacity, the attacker cannot systematically forge for a long enough time to compromise the system. Additional methods must be used to secure the use of such keys to avoid exploitation of such use for forgery.

Generally, consistency checking in digital forensics also gains its utility from computational advantage. In this case, normal operation of computer systems produces redundant traces, and these traces can be compared for consistency. While trivial forgeries can function against detectives unfamiliar with consistency methods, the complexity of creating a forgery that cannot be detected in a larger overall protected system is thought to be so high that it is infeasible in almost all cases.³ Again, the forger cannot anticipate and alter enough traces to defeat all feasible consistency checks, and the alteration of these traces introduces potential inconsistencies with still other traces that are also subject to detection. ³F. Cohen, “Digital Forensic Evidence Examination”, ASP Press, 2009-2011.

Thus, consistency checking leverages computational advantages of defenders over attackers. In doing so, it refutes the common but false assumption that the defender has to protect against all possible attacks in detail while the attacker only has to find one attack the defender failed to defend against.

In many types of controlled systems, under normal operating conditions, a failure in a sensor, effector, or other system component will be reflected in altered signals indicative of a move away from the weighted “center” of the control envelope (or, the set point). The response from the automated control system will be to compensate by altering effectors so as to move the system back toward the center of the control envelope. Of course there may be some losses or variations (e.g., leaked fluids, changes in the characteristics of an electrical signal, change in ambient temperature in a temperature controlled environment, etc.) resulting from the actual fault (e.g., a hole in a pipe, a fault or defect in an electrical circuit, an open door or window or faulty heating or cooling system, etc.), and the control system will continue to compensate as well as it can, and potentially alert operators to the fault condition (e.g., fluids are running low, signal characteristics are different from expectations, temperature is not being maintained, etc.).

If an attacker alters a sensor to produce false information, the response from the automated control system may be to compensate by altering the effectors in response under the assumption that the information is true. Thus, a reflexive control attack is realized as the “reflexes” of the control system react to the information available. To some tolerance, the changes will be within the control envelope of the system and stability will be retained, even if some other performance effects may occur (e.g., undetected theft of fluids or excess line voltage). As tolerances are exceeded, the control envelope may be exceeded and the system may become unstable, may collapse, and may, as a side effect, destroy physical components. However, if there are multiple sensors, to the extent that unaltered sensors are affected by control changes based on false information, the unaltered sensors may generate signals inconsistent with the altered sensor signals, supporting inconsistency detection.

If redundant sensors are separate and different, common mode failures may also be avoided and better diagnosis supported. The same is true of an altered effector or an altered physical system, and to the extent that there are redundant control systems, to an altered control system.

Thus, according to specific embodiments, a system or method described herein uses a control system to detect inconsistencies between sensors, optionally diagnoses the most likely bad sensor(s) and overall situation, and in further embodiments, compensates for and reduce the trust and dependence on the false signals.

At some level of induction and/or suppression of signals (i.e., alteration), so many signals may be altered that an entirely false picture that is itself consistent may result. If every system and component is taken over by an attacker, the system may not detect or report anything. However, even short of this, the deception may be of sufficient quality as to mimic the legitimate control system and deceive the operator and the systems they depend upon.

### Induction and Suppression of Signals (e.g., Perturbations or Alterations) for Detection

To compensate for various types of attacks or failures, an alternative approach is to, in a systematic way, intentionally induce abnormal and suppress normal control signals so as to produce systematic changes in the overall system that generally, (1) remain within the safety margins of the system control envelope, and (2) produce time variant effects within and throughout the system under control that can be predicted and detected. By doing so, the sophisticated control system may induce changes that ripple through the system as a form of diagnostic test, creating sequences of alterations that remain safe and relatively efficient while inducing feedback that reveals attempts to circumvent normal controls.

Stated in different terms, specific embodiments involve a controlled system with one or more controllable effectors that have some effect on one or more parameters of the system and one or more detectors that can sample parameters of the system. A mechanism or logic module or system data specifies one or more alterations for the one or more effectors. Generally, the mechanism produces alterations for the effectors that result in acceptable but detectable alterations in the system parameters. Before, as, and/or after altered effects are induced, sensor data is collected for analysis. Based on the nature of the system and the specified alterations, predictions are made of expected system behaviors as reflected in sensor data. The predictions are compared to the sensed results and, to the extent that there are differences beyond those associated with normal accuracy and precisions of the system, inconsistencies are detected.

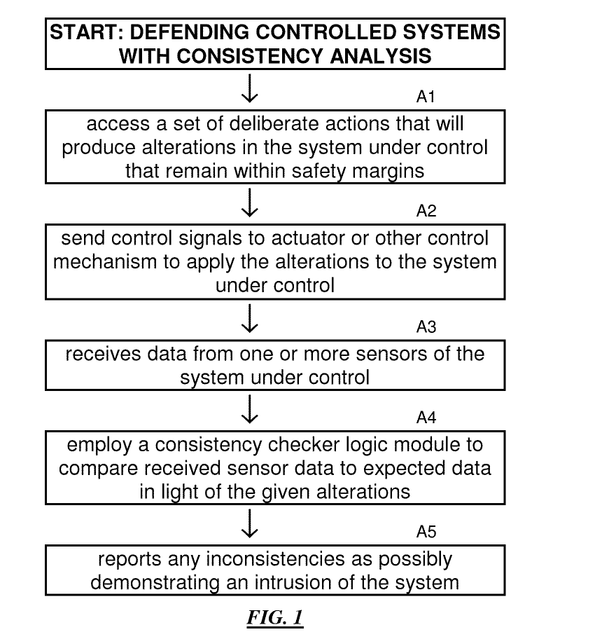

FIG. 1 is a flow chart illustrating a method of detecting deceptive actions using consistency analysis in control systems during normal operation according to specific embodiments. In this example, specific embodiments proceeds by first accessing or determining a set of deliberate actions that will produce alterations in the system under control that remain within the safety margins of the system control envelope (Step A1). Specific embodiments next use an actuator or other control mechanism to apply the alterations to the system under control (Step A2). Specific embodiments next receive data from one or more sensors of the system under control (Step A3). Specific embodiments next using a consistency checker logic module to compare received sensor data to data that would be expected in light of the given alterations (Step A4). Specific embodiments next report any inconsistencies as possibly demonstrating an intrusion of the system.

Specific embodiments differ from various “stress testing” and “confidence testing” of control systems. Such testing, which has been routine for many years, generally directly subjects a system to an alteration or perturbation to determine if a sensor and control system is responding or working as expected. This is part of routine testing and maintenance of control systems.

The preset invention, however, subjects systems to generally a number of different perturbations at generally varying times and sequences. This is because the purpose of the perturbations is not to determine simply if a detector or effector is working, but to detect whether there has been a deliberate alteration of an effector or sensor.

As will be further understood from the teachings provided herein, the present invention encompasses a variety of specific embodiments for performing these steps. A number of these embodiments provide further novel aspects to protective solutions for different control systems.

In further embodiments, by doing so in an externally unpredictable sequence, specific embodiments can detect a malicious actor wishing to alter the control system if that actor is unable to predict the proper control signals in time to reflect a globally consistent system state and variance, even in cases where the attacker has control of most of the sensors and effectors.

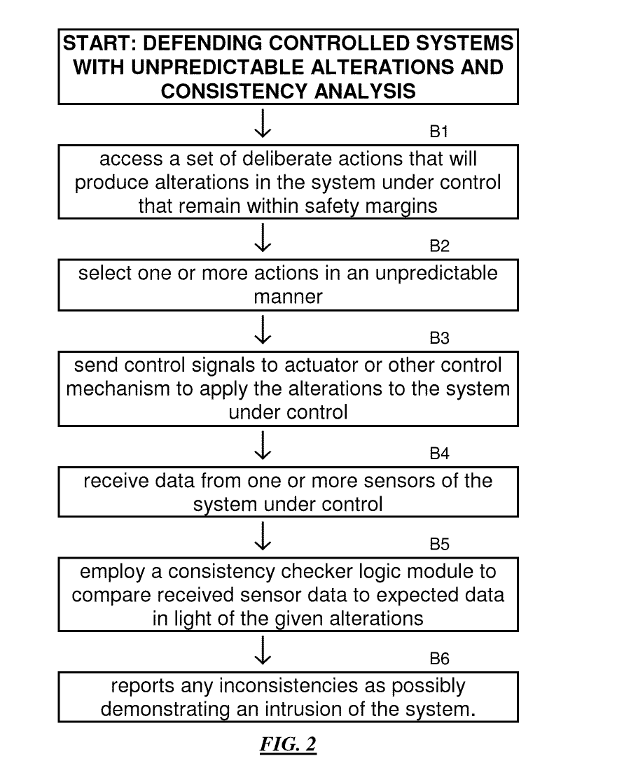

FIG. 2 is a flow chart illustrating a method of detecting deceptive actions in controlled systems using unpredictable deliberate alterations and consistency checking during normal system operations according to specific embodiments. In this further example, specific embodiments proceeds by first accessing or determining a set of deliberate actions that will produce time varying alterations in the system under control that remain within the safety margins of the system control envelope (Step B1). Specific embodiments next use a selector to determine one or more actions in an unpredictable manner, such as by using a random number generator. (Step B2). Specific embodiments next use an actuator or other control mechanism to apply the alterations to the system under control (Step B3). Specific embodiments next receive data from one or more sensors of the system under control (Step B4). Specific embodiments next using a consistency checker logic module to compare received sensor data to data that would be expected in light of the given alterations (Step B5). Specific embodiments next report any inconsistencies as possibly demonstrating an intrusion of the system.

Thus, according to specific embodiments, computational advantage is used by the control system designer to detect and potentially diagnose malicious alteration of one or more of the effectors and/or detectors and/or other aspects of the controlled system.

In further specific embodiments, consistency analysis of sensors and/or redundant sensors and/or effectors is used to detect alteration of system operations even in the presence of subversion and without necessarily performing deliberate alterations. In further embodiments, the system includes one or more specific deliberate alteration or perturbation routines for a controlled system and uses a consistency checker to determine if the deliberate perturbations had the predicted effect on available trace data from sensors or other sources.

Further embodiments may include a response logic module that can take further action or alert to the presence of possible subversion efforts and/or diagnose possible causes of the observed effects.

### EXAMPLES

In discussing examples, there are two broad illustrative cases that are illustrative of specific embodiments: a quasi-static case in which the system is assumed to be over-damped and fed by more or less constant volumes relative to measurement time frames, and a dynamic case in which the system is under-damped and constantly changing, so that waves normally build upon each other.

In the quasi-static case, subject to small-time delays associated with the propagation of change, for example, conservation of mass dictates that the volume in a repository is equal to the sum of all the flows into and out of that repository. Because the system is quasi-static, the conservation rule can be applied to within the measurement precision of sensors, and variations are detected as inconsistent if they exceed the variances in precision, again subject to the relatively small propagation delay. For example, the detection time for a leak is dictated by the precision of measurements, so that a device that measures a water tank to the nearest 1000 liters will normally detect leaks totaling no more than 2000 liters, essentially as it happens. For a system of tanks and pipes, the height and pressure of each tank and pipe in the system should match the initial values and flows in and out, and an attempt to provide false signals for any single sensor will result in a detection as soon as the changes create a mismatch. By altering multiple sensors, it is feasible to shift apparent usage from one area to another only to the extent that this does not create a downstream inconsistency. Thus, at downstream endpoints, a malicious actor could steal water and place the blame on another party sharing the endpoint, but theft in the middle of a system would be detected by the downstream loss, and in order to avoid such detection, forged signals from downstream sensors would be required in the proper combinations so as to create a consistent resulting overall system. Time to detection depends on the volumes flowing and sensitivity of sensors, so that for 2000 liters of loss in a system flowing 200 liters per second, 10 seconds plus propagation time plus sensor scan time limits the time till detection. However, noise factors such as rain and wind may affect volumes and sensor precision. For example, if it rains, the system will gain water that could be stolen as it is gained.

For passive detection, consistency analysis may still not detect forgeries by parties who understand and can model the system reasonably well, perhaps including taking sensor readings from other (downstream) sensors and forging multiple values so as to retain consistency of the overall system in near-real-time. However, according to specific embodiments, by adding active alterations to the system through actuator changes, a system incorporating specific embodiments will further resist modeling by malicious actors. For example, instead of having a fully predictable control system that seeks to keep water in tanks at constant set points, suppose the system intentionally changed set points over time. Now the attacker seeking to model the system has to take into account the changes in set points in order to create a consistent forgery. Instead of simply forging sensor readings to cover up a loss for a time, the attacker has to calculate the proper values for the entire downstream system taking the changes in all set points into account, or the forged values may be internally consistent, but will be inconsistent with the changed set points. The control system's model of the overall system is unchanged, and detection remains the same problem, while forgery becomes far harder and requires access to and analysis of all of the changed set points for effect.

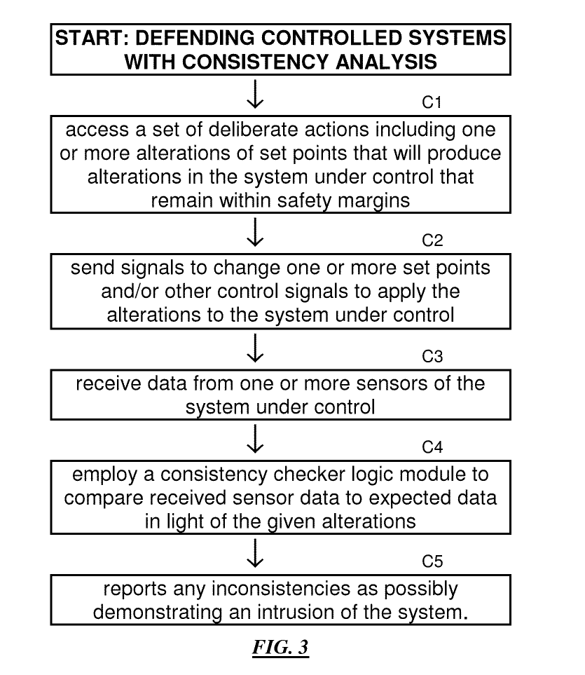

FIG. 3 is a flow chart illustrating a method of detecting deceptive actions in controlled systems using alterations of set points and consistency checking during normal system operations according to specific embodiments. In this further example, specific embodiments proceeds by first accessing or determining a set of deliberate actions that will produce time varying alterations in the system under control that remain within the safety margins of the system control envelope, where one or more of the actions involve altering a set point of one or more components of the system (Step C1). Specific embodiments next use a selector to determine one or more actions. (Step C2). Specific embodiments next use an actuator or other control mechanism to apply the alterations to the system under control, including varying one or more set points (Step C3). Specific embodiments next receive data from one or more sensors of the system under control (Step C4). Specific embodiments next using a consistency checker logic module to compare received sensor data to data that would be expected in light of the given alterations (Step C5). Specific embodiments next report any inconsistencies as possibly demonstrating an intrusion of the system.

In dynamic systems, unlike the quasi-static case, an under damped system with changes that do not have time to propagate to stability produces a far more complex challenge for both attacker and defender. Conservation remains true, of course, but measurement becomes far harder. A sensor measuring a waveform may vary significantly from the average value, and integration does not produce a reliable mean value in an under damped system over a short time frame. Creating additional dynamics is far more problematic in that, without complete knowledge of the system state over time, induction of changes may force the system out of stability and generate positive feedback, ultimately resulting in catastrophic failure. Sensors may be at nodes in the system providing incorrect feedback, and perhaps more importantly, the utility gained in detection may be nullified by the large variance in sensor values in different operating modes.

On the other hand, a control system according to specific embodiments that contains sufficiently tuned methods and effectors and sensors to solve these problems, provides a far more complex situation for the attacker. In this situation, the attacker must launch their attack in an environment where the attacker's changes may produce system instabilities that make the attacker's changes obvious quickly. The attacker must compute values upstream and downstream, and the computation of effects of alterations may take too long for real-time analysis.

Using systems and methods according to specific embodiments described herein, the defender can guard against attacks by: (1) determining an alteration or perturbation to the system, (2) calculating expected values with time using an analytical process that does not need to be performed in real-time, and (3) then using actuators of the control system in combinations and sequences so as to produce predictable dynamics that are detectable by one or more sensors. The attacker without advanced knowledge of the planned changes is forced to try to do real-time analysis of the effects of the changes and produce solutions in time to forge sensor data to within the fidelity required to fool the defender's predictive system. If the complexity of calculation is too high for the attacker to do the necessary computations in real-time, the attacker will not be able to produce consistent results and will be detectable. Further, to the extent that alterations within a range may be made within the safe operating envelope of the system, those changes may be made before calculating the expected values, and based on random or pseudo-random, unpredictable, or hard to predict factors, so that neither the defender nor the attacker knows in advance what specific effects will be observed. Since the defender need not always detect inconsistencies in real-time, in such a system, even the attacker who knows everything about the defensive system cannot make systematic alterations to the system so as to avoid detection. Thus, even an expert insider cannot defeat a system protected by this defensive method according to specific embodiments.

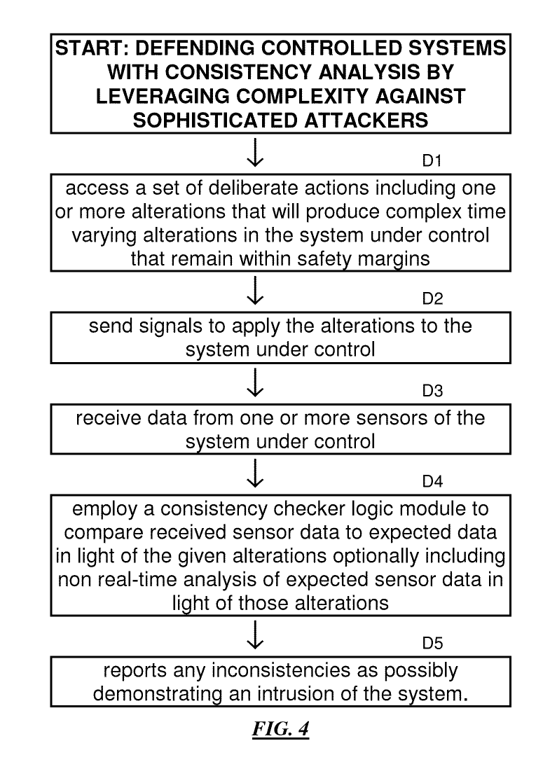

FIG. 4 is a flow chart illustrating a method of detecting deceptive actions using consistency analysis and complex time varying alterations in control systems to leverage computation complexity to thwart sophisticated attackers according to specific embodiments. In this further example, specific embodiments proceed by first accessing or determining a set of deliberate actions that will produce complex time varying alterations in the system under control that remain within the safety margins of the system control envelope, where one or more of the actions involve altering system parameters that produce complex time varying alterations (Step D1). Specific embodiments next use a selector to determine one or more actions. (Step D2) and then next use an actuator or other control mechanism to apply the alterations to the system under control, including varying one or more set points (Step D3). Specific embodiments next receive data from one or more sensors of the system under control (Step D4). Specific embodiments next using a consistency checker and system analysis logic module to compare received sensor data to data that would be expected in light of the given alterations (Step D5). Specific embodiments next report any inconsistencies as possibly demonstrating an intrusion of the system.

According to further aspects of specific embodiments, specific embodiments addresses situations where intentional variations in flows for detection may be problematic in systems, such as power infrastructure, where back forces and phase shifts may result from attempts to alter flows. While at distribution points, such changes are relatively straightforward with smart meter technologies, and force levels are relatively low, if many such changes are made in concert, the combined forces may be enormous. Thus, scheduling of changes may become a serious challenge for the overall system, requiring a more sophisticated alteration approach. In transmission, shifting enough power to produce changes in excess of detection thresholds may require so much energy that the system becomes less stable, back forces on generation may be problematic and damaging, interactions of wave forms may cause nodes in the system in excess of allowable tolerances, and compensation for rapid changes in load that occur all the time may force the detection thresholds to be set so high as to make large-scale dynamic detection infeasible without risking system stability. Computation of changes and detectable effects may be so complex as to make dynamics infeasible.

Thus, the systems and methods as described herein in further embodiments includes analysis and simulations to determine the maximum perturbations or alterations that may reasonably be made and may include one or more additional effectors or detectors specifically for the purpose of inducing diagnostic changes in the system.

Thus, the present invention involves using consistency analysis and intentional deception in the form of induction and/or suppression of signals to detect accidental and intentional acts altering control systems, and allows defenders to gain computational leverage over attackers.

Specific embodiments provide solutions in the quasi-static case that in some cases can be implemented with relative little planning or analysis or adjustment to the overall system. In the dynamic case, specific embodiments provides for more complex analysis of systems and adoption of methods and sensors and effectors that, while more complex to implement, are also potentially far more advantageous to the defender.

Various embodiments provide methods and/or systems for defending against attacks or subversions of controlled systems using alterations and checking for consistency in order to leverage complexity. The consistency checking and alteration routines can be implemented on a general purpose or special purpose information handling appliance using a suitable programming language such as Java, C++, Cobol, C, Pascal, Fortran, PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

Furthermore, it is well known in the art that logic systems and methods such as described herein can include a variety of different components and different functions in a modular fashion. Different embodiments can include different mixtures of elements and functions and may group various functions as parts of various elements. For purposes of clarity, specific embodiments are described in terms of systems that include many different innovative components and innovative combinations of innovative components and known components. No inference should be taken to limit the invention to combinations containing all of the innovative components listed in any illustrative embodiment in this specification.

### Example System Embodiment

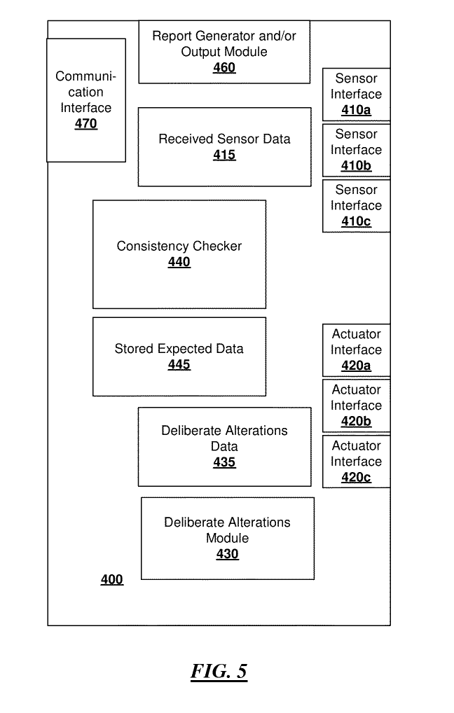

FIG. 5 is a block diagram showing a representative example logic system and logic modules according to specific embodiments. FIG. 5 is used to describe the structure and operation of a consistency system 400. System 400 may be incorporated into a logic control system of a facility as will be understood in the art or may be in a separate information device that is in electronic communication with other relevant control systems in a facility. Persons skilled in the art will recognize that configurations and arrangements other than those provided in FIG. 5 can be used without departing from the spirit and scope of the present invention. For example, all of the logical components may reside and be executed in a single computer hardware system. Alternatively, the logical components may be distributed across multiple hardware systems and may execute or communicate with off site and network components as desirable in any particular installation. For example, portions of the components shown may reside in a location far from the system under control and communication may take place over a local area network or over the Internet. Data may be communicated by any module over the Internet or other network to an offsite facility as desired and configured for particular installations.

System 400 comprises one or more sensor interfaces, such as examples 410a-c. As incorporated into a system of specific embodiments, these interfaces may include electronic components or logic modules for communicating with external system sensors or may simply logic modules that receive data from another control software module. Data received from the sensors is stored in volatile or non-volatile Received Sensor Data store 415.

One or more actuator interfaces, such as examples 420a-c, also may include electronic components or logic modules for communicating with external system actuators or may be logic modules that transmit data to an external control software module that controls actuator functions. These actuators are instructed by Deliberate Alterations Module 430 using Deliberate Alterations Data 435.

As described elsewhere herein, Consistency Checker 440 reads received sensor data and uses Stored Expected Data 445 to determine if the behavior of the system is consistent under one or more deliberate applied alterations. As described above, the alterations and consistency checking can vary widely in complexity in particular embodiments.

Results of the consistency check are used by Report Generator and/or Output Module 460 to communicate whether or not there has been any inconsistency that would indicate intrusion or malicious alteration or accidental alteration or failure of the system.

An optional Communication Interface 470 provides communication between the system under control, other logic modules, and any other authorized communication.

Persons skilled in the relevant art(s) will appreciate that the functions of the modules may be implemented entirely in software or as a combination of hardware and software.

### Embodiment in a Programmed Information Appliance

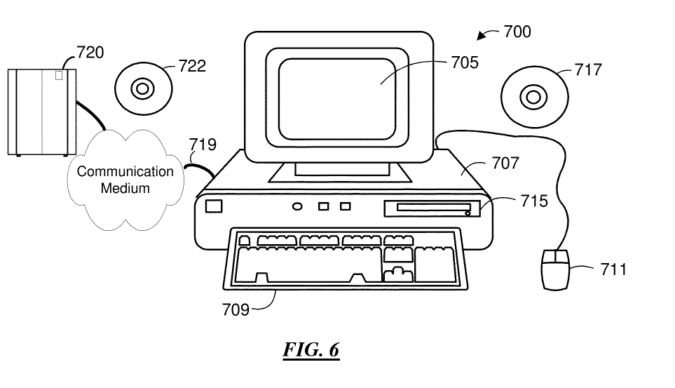

FIG. 6 is a block diagram showing a representative example logic device in which various aspects of the present invention may be embodied. As will be understood to practitioners in the art from the teachings provided herein, specific embodiments can be implemented in hardware and/or software. In some embodiments, different aspects can be implemented in either client-side logic or server-side logic. As will be understood in the art, specific embodiments or components thereof may be embodied in a fixed media program component containing logic instructions and/or data that when loaded into an appropriately configured computing device cause that device to perform according to specific embodiments. As will be understood in the art, a fixed media containing logic instructions may be delivered to a user on a fixed media for physically loading into a user's computer or a fixed media containing logic instructions may reside on a remote server that a user accesses through a communication medium in order to download a program component.

FIG. 6 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of specific embodiments. One type of logical apparatus that may embody specific embodiments is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. Specific embodiments may be embodied in whole or in part as software recorded on this fixed media. Communication port 719 may also be used to initially receive instructions that are used to program such a system and may represent any type of communication connection.

Specific embodiments also may be embodied in whole or in part within the circuitry of an application specific integrated circuit (ASIC) or a programmable logic device (PLD). In such a case, specific embodiments may be embodied in a computer understandable descriptor language, which may be used to create an ASIC, or PLD that operates as herein described.

### Other Embodiments

The invention has now been described with reference to specific embodiments. The general structure and techniques, and more specific embodiments that can be used to effect different ways of carrying out the more general goals are described herein. Other embodiments will be apparent to those of skill in the art. In particular, one example control and analysis device has generally been illustrated as a personal or workstation computer. However, the digital computing device is meant to be any information analysis device or system and could include such devices as laboratory, manufacturing, or enterprise equipment, including environmental or other control systems. It is understood that the examples and embodiments described herein are for illustrative purposes and that various modifications or changes in light thereof will be suggested by the teachings herein to persons skilled in the art and are to be included within the spirit and purview of this application and scope of the claims. All publications, patents, and patent applications cited herein or filed with this application, including any references filed as part of an Information Disclosure Statement, are incorporated by reference in their entirety.

Where a specific numerical value is mentioned herein, it should be considered that the value may be increased or decreased by 20%, while still staying within the teachings of the present application, unless some different range is specifically mentioned. Where a specific range of values is mentioned herein, it should be considered that the upper and/or lower bounds of the range, and or value of the range may be increased or decreased by 20%, while still staying within the teachings of the present application, or increased or decreased by any amount consistent with specific embodiments as described herein. Where a specified logical sense is used, the opposite logical sense is also intended to be encompassed.

### REFERENCES

[1] M Keeney, E. Kowalski, D. Cappelli, A. Moore, T, Shimeall, S. Rodgers, “Insider Threat Study: Computer System Sabotage in Critical Infrastructure Sectors”, January 2005.
[2] E. Shaw, K. Ruby, and J. Post, “Insider Threats to Critical Information Systems: Typology of Perpetrators, Security Vulnerabilities, Recommendations”, Aug. 31, 1999. ASD-C3I-OIO—Contract #98-G-7900, Task Letter Number 001:Insider Threat Profile.
[3] E. Shaw, K. Ruby, and J. Post, “Insider Threats to Critical Information Systems: Characteristics of the Vulnerable Critical Information Technology Insider (CITI) Contract Nr. N39988-97C-7850, Sep. 25, 1998.
[4] F. Cohen, “Simulating Cyber Attacks, Defenses, and Consequences”, IFIP-TC11, ‘Computers and Security’, 1999, vol. 18, no. 6, pp. 479-518(40)
[5] F. Cohen, “A Cryptographic Checksum for Integrity Protection”, IFIP-TC11 “Computers and Security”, V6#6 (December 1987), pp 505-810.
[6] F. Cohen, “A Method for Forensic Analysis of Control”, IFIP TC11, Computers & Security, V29#8, pp 891-902, November, 2010, doi: 10.1016/j.cose.2010.05.003
[7] B. Carrier, “A Hypothesis-Based Approach to Digital Forensic Investigations”, Dissertation, Purdue, CERIAS Tech Report 2006-06, 2006.
[8] P. Gladyshev, “Formalising Event Reconstruction in Digital Investigations”, Dissertation, University College Dublin, 2008.
[9] F. Cohen, “A Case Study in Forensic Analysis of Control”, (accepted, pending publication) Journal of Digital Forensics, Security, and the Law, 2011.
[10] F. Buchholz, “Error Rates for Timestamp Forensic Analysis”, North Eastern Forensics Exchange (ACM), September 2010.
[11] F. Cohen, “Digital Forensic Evidence Examination”, [Note: Chap 3—” The physics of digital information” is available online at http://infophys.com/InfoPhys.pdf] ASP Press, 2009-2011.
[12], F. Cohen, “A Note on Detecting Tampering with Audit Trails”, 1995, Available at the URL: http://all.net/books/tech/audmod.pdf
[13] J. Post, “The Anatomy of Treason”, Psychological contributions to selective targeting, pp 35-37.
[14] F. Cohen, I. Marin, J. Sappington, C. Stewart, and E. Thomas “Red Teaming Experiments with Deception Technologies”, 2001. http://all.net/journal/deception/RedTeamingExperiments.pdf
[15] S. Willassen, Finding Evidence of Antedating in Digital Investigations”, ARES 2008 The Third International Conference on Availability, Reliability and Security, 2008.
[16] P. Gladyshev and A. Enbacka, “Rigorous Development of Automated Inconsistency Checks for Digital Evidence Using the B Method “, International Journal of Digital Evidence, Fall 2007, Volume 6, Issue 2.
[17] F. Cohen, “Method and Apparatus for Providing Deception and/or Altered Execution of Logic in an Information System U.S. Pat. No. 7,296,274.
[18] Svein Yngvar Willassen, “Timestamp Evidence Correlation”, Presentation at IFIP WG 11.9 International Conference on Digital Forensics, January, 2008.
[19] Svein Yngvar Willassen, “Hypothesis-based investigation of digital timestamps”, chapter in Advances in Digital Forensics IV, Ray and Shenoi ed., Springer, ISBN#978-0-387-84926-3, 2008.
[20] E. Shaw, K. Ruby, and J. Post, “The Insider Threat to Information Systems—The Psychology of the Dangerous Insider”, Security Awareness Bulletin, No. 2-98, 1998.
[21] J. Post, personal communications—extracted from a contemporary undisclosed article.
[22] Committee on Identifying the Needs of the Forensic Sciences Community, “Strengthening Forensic Science in the United States: A Path Forward”, ISBN: 978-0-309-13130-8, 254 pages, (2009); Committee on Applied and Theoretical Statistics, National Research Council.
[23] Scientific Working Group on Digital Evidence (SWGDE) Position on the National Research Council Report to Congress—Strengthening Forensic Science in the United States: A Path Forward“, 2009.
[24] Reference Manual on Scientific Evidence—Second Edition—Federal Judicial Center, available at http://air.fjc.gov/public/fjcweb.nsf/pages/16.
[25] U.S. Department of Justice, “A Review of the FBI's Handling of the Brandon Mayfield Case”, unclassified executive summary, January 2006. (http://www.justice.gov/oig/special/s0601/exec.pdf)
[26] F. Cohen, et. al. “A Mathematical Structure of Simple Defensive Network Deceptions”, IFIP-TC11, ‘Computers and Security’, Volume 19, Number 6, 1 Oct. 2000, pp. 520-528(9)
[27] F. Cohen, “Managing Network Security” (series of articles in Network Security Magazine)—The Deception Defense”, Network Security, November, 2001.
[28] F. Cohen, “Frauds, Spies, and Lies, and How to Defeat Them”, ASP Press, 2005.
[29] F. Cohen, “Issues and a case study in bulk email forensics”, Fifth annual IFIP WG 11.9 International Conference on Digital Forensics, Jan. 27, 2009, published as “Bulk Email Forensics” in the conference publication.
[30] F. Cohen, “Defending Against the Evil Insider”, Burton Group Report, November 2005
[31] F. Cohen, “Intrusion Detection and Response Systems”, Burton Group Report, October, 2003
[32] T. Stallard, “Automated Analysis for Digital Forensic Science”, Masters Thesis, Computer Science Department, University of California Davis, 2002.
[33] Timestomp is a utility co-authored by developers James C. Foster and Vincent Liu. The software's goal is to allow for the deletion or modification of time stamp-related information on files, . . . http://www.forensicswiki.org/wiki/Timestomp, 2005.
[34] http://msdn.microsoft.com/en-us/library/ms724284.aspx “Not all file systems can record creation and last access time and not all file systems record them in the same manner. For example, on NT FAT, create time has a resolution of 10 milliseconds, write time has a resolution of 2 seconds, and access time has a resolution of 1 day (really, the access date). On NTFS, access time has a resolution of 1 hour.”
[35] C. Boyd and P. Forster, “Time and date issues in forensic computing—a case study”, Digital Investigation (2004) pp. 18-23, 2004.
[36] M. Stevens, “Unification of relative time frames for digital forensics”, Digital Investigation, Volume 1, Issue 3, 2003.
[37] F. Cohen, “Consistency Under Deception Implies Integrity”, ICSJWG Newsletter—September 2011

1. An apparatus for detecting subversions of a system under control comprising:
one or more data communication interfaces wherein at least one interface is configured to receive data from one or more sensors of one or more parameters of the system and at least one interface is configured to transmit control data to one or more effectors of the system;
stored perturbation information specifying how to determine allowable intentional alterations of effector control data and specifying how to determine expected sensor data that would result from the alterations;
one or more logic modules collectively configured to transmit and receive data on one or more data communication interfaces, to use the stored perturbation information, to apply the perturbations, to determine the expected sensor data, and to use the received data to perform one or more consistency checks between expected or predicted sensor data and detected sensor data as a result of alterations;
an output generator of said logic processor producing output identifying one or more of: presence of, absence of, or details regarding inconsistencies detected.

2. The apparatus of claim 1, further wherein said stored perturbation information comprises one or more rules specifying control signals that produce systematic changes in the overall system and the expected changes that would be detected by sensors under such rules.

3. The apparatus of claim 1 wherein the perturbation information has been rigorously tested or otherwise verified to determine that resulting system perturbations are within the safety margins of the control envelope of the system.

4. The apparatus of claim 1 further wherein said stored perturbation information produces time variant effects within and throughout the system under control.

5. The apparatus of claim 1 further comprising:
a scheduler module for applying different portions of said perturbation information in sequences so that a malicious actor wishing to alter the system will be unable to predict the proper responses in time to pass the consistency checks, even when the malicious actor has control of one or more of the sensors and effectors.

6. The apparatus of claim 5 further wherein:
the scheduler module is configured to apply different portions of said perturbation information in random, pseudo-random or unpredictable sequences.

7. The apparatus of claim 1 further wherein computational advantage is used by the control system designer to detect and potentially diagnose malicious alteration.

8. The apparatus of claim 1 further comprising:
a further set of consistency information and/or rules and/or facts comprising one or more rules and/or facts that describe or incorporate:
laws of physics,
assumptions about the operating environment,
operating procedures normally followed,
statements of fact,
facts consistent with identified traces of activities,
hypotheses,
assertions based on human statements or testimony, and/or other
assertions of things that must normally be true or are specifically known or thought to be true; and
further wherein the consistency checker is configured to detect inconsistencies within and between elements in the set of information and/or rules and/or facts and/or sensor and/or effector data.

9. The system of claim 1 further wherein:
the set of information and/or rules and/or facts contains methods for checking consistency of traces stemming from operations of a physical system and facts gathered from said physical system.

10. The system of claim 1 further wherein:
the set of information and/or rules and/or facts contain information and/or rules and/or facts determined by or determining time, place, or other physical events related to operations.

11. The apparatus of claim 1 further comprising:
a hardware processor;
a computer-readable medium carrying at least one sequence of instructions to access rules and facts and perform consistency checking.

12. A security system for a controlled system comprising:
control system data storage storing default and configuration data of the controlled system;
perturbations data storage storing data regarding one or more perturbations and expected responses for the perturbations;
control system interfaces configured to communicate with a plurality of sensors and effectors operating in a system under control;
consistency data storage storing data for consistency analysis of data traces from the plurality of sensors and effectors and other available controlled system data;
security system processor or processors comprising one or more processing elements, wherein the security system processor or processors is in communication with the data storage and the control system interfaces and wherein the security system processor is programmed or adapted to perform the steps comprising:
receiving control system data from said one or more sensors and effectors;
performing a consistency analysis on the control system data;
reading one or more perturbations from said perturbation data storage;
selecting one or more perturbation routines;
causing the selected one or more perturbation routines to be executed, wherein the selected one or more perturbation routines can be executed by the control system, the security system, or by combinations thereof;
wherein the selected one or more perturbation routines are expected to cause at least one detectable response in one or more effectors or sensors, without causing operation of said controlled system outside of allowed parameters;
receiving control system data from said one or more sensors and effectors under perturbation;
performing an expectancy and/or consistency analysis on the control system data under perturbation;
reporting results of the expectancy and/or consistency analysis on the control system data under perturbation when any value indicates an unexpected and/or inconsistent result to the perturbation.

13. Non-transitory machine-accessible and readable media comprising software that, when executed by a control system with logic processing and data interface capabilities and operating on a system under control, configures the control system to:
apply one or more deliberate alterations to the system under control;
read sensor data from one or more sensors connected to the system under control;
use consistency data to determine if the sensor data is consistent with the one or more deliberate alterations; and
report one or more of presence of, absence of, or details regarding any inconsistencies detected.

14. A method for detecting subversions of a system under control comprising:
applying one or more deliberate alterations to the system;
reading sensor data from one or more sensors connected to the system;
using consistency data to determine if the sensor data is consistent with the one or more deliberate alterations;
reporting one or more of presence of, absence of, or details regarding any inconsistencies detected.

15. The method of claim 14 further comprising:
reading alteration information specifying allowable deliberate alterations and expected sensor data that would result from the alterations.

16. The method of claim 14 further comprising:
verifying alteration data to determine that resulting system perturbations are within the safety margins of the control envelope of the system.

17. The method of claim 14 further comprising:
applying one or more deliberate alterations that produce time variant effects within and throughout the system under control.

18. The method of claim 14 further comprising:
applying deliberate alterations in sequences so that a malicious actor wishing to alter the system will be unable to predict the proper responses in time to pass the consistency analysis even when the malicious actor has control of one or more of the sensors and effectors.

19. The method of claim 15 further wherein:
applying deliberate alterations comprises applying different alterations in random, pseudo-random or unpredictable sequences.

20. The method of claim 14 further wherein computational advantage is leveraged to detect and potentially diagnose malicious alteration.

21. The method of claim 14 further comprising:
determining one or more possible explanations of a detected inconsistency and reporting those explanations.
